(19) United States
(12) Patent Application Publication
(10) Pub. No.: US 2026/0292767 A1
(43) Pub. Date: Sep. 24, 2026

(54) ANGLE BASED SIDELINK POSITIONING

(71) Applicant: Apple Inc., Cupertino, CA (US)

(72) Inventors: Chunxuan YE, San Diego, CA (US); Dawei ZHANG, Saratoga, CA (US); Hong HE, San Jose, CA (US); Huaning NIU, San Jose, CA (US); Oghenekome OTERI, San Diego, CA (US); Wei ZENG, Saratoga, CA (US); Weidong YANG, San Diego, CA (US)

(21) Appl. No.: 19/473,026

(22) PCT Filed: Apr. 2, 2024
(86) PCT No.: PCT/US2024/022626

§ 371 Date: Oct. 6, 2025

Related U.S. Application Data
(60) Provisional application No. 63/457,838, filed on Apr. 7, 2023.

(51) Int. Cl. H04W 64/00; G01S 5/02; G01S 5/04; H04B 7/06; H04L 5/00; H04W 92/18

(52) U.S. Cl. CPC H04W 64/00; G01S 5/0236; G01S 5/04; H04B 7/0695; H04L 5/0048; H04W 92/18

(57) ABSTRACT

Methods and systems are configured for sending, from a network to an anchor user equipment (UE), a request for data describing a sidelink position reference signal (SL-PRS) transmission from a target UE to the anchor UE; and receiving, at the network from the anchor UE, measurement results data comprising a measurement of a beam that is transmitted from the target UE to the anchor UE in the SL-PRS, the measurement results specifying an angle of arrival (AoA) of the beam that is measured at the anchor UE.

### CLAIM OF PRIORITY

This application claims priority under to U.S. patent application Ser. No. 63/457,838, filed on Apr. 7, 2023, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

For sidelink transmissions, a user equipment (UE) can be configured to perform angle of arrival (AoA) measurements. In an uplink (UL) scenario, the UE sends a UL sounding reference signal (SRS). An SRS includes a reference signal for UL transmissions (e.g., transmitted by the UE) so that a base station or next generation node (gNB) can perform channel quality estimation for the UL transmission. The base station performs a UL channel estimation from the physical uplink shared channel (PUSCH) demodulation reference signal (DMRS), but the PUSCH DMRS is transmitted only when PUSCH is scheduled and only with the bandwidth in which PUSCH is scheduled. The SRS can be transmitted independently of PUSCH scheduling and PUSCH bandwidth, which is the number of PUSCH resource blocks (RBs) available. For time division duplex (TDD) modes, a base station or node (gNB) can utilize a channel estimation result from the SRS not only for UL scheduling but also for downlink (DL) scheduling, based on channel reciprocity in TDD.

Once the UL SRS is sent by the UE, the base station measures the UL-SRS reference signal received power (RSRPs) with receiver (Rx) beam sweeping. The base station (or a part of the network, NW) determines an UL AoA of each of an azimuth and zenith beams. The network then determines a UE location based on the AoA values and the base station (node) locations. Further details are described in 3GPP TS 38. 305, clause 8.14. The UL-AoA positioning method makes use of the measured azimuth and zenith of arrival at multiple receive points (RPs) of uplink signals transmitted from the UE. The RPs measure azimuth AoA (A-AoA) and zenith AoA (Z-AoA) of the received signals based on assistance data received from the positioning server. The node uses the assistance data and the resulting measurements, along with other configuration information, to estimate the location of the UE.

A process for downlink (DL) angle of departure (AoD) is now described. A node (e.g., a gNB) sends a DL positioning reference signal (PRS) with transmitter (Tx) beam sweeping. The position reference signal is configured to provide the gNB (or receiving device) with a reference signal from which beam strength and direction are measured by the receiving device. The UE measures DL-PRS RSRPs with a fixed receiver (Rx) beam. The UE reports DL-PRS RSRPs to the network. The network determines a DL AoD of an azimuth beam and a zenith beam. The network determines the UE location based on the AoD and the node locations. The DL-AoD positioning method makes use of the measured DL-PRS-RSRP of downlink signals received from multiple transmission points (TPs) at the UE. The UE measures the DL-PRS-RSRP of the received signals using assistance data received from the positioning server, and the resulting measurements are used along with other configuration information to locate the UE in relation to the neighboring TPs. Further details are described in 3GPP TS 38. 305, clause 8.11.

### SUMMARY

This document describes methods and systems for sidelink (SL) transmissions in a wireless communications network. This document describes angle-based sidelink positioning, specifically SL positioning for a UE that is part of telecommunication networks such as 5G NR networks and beyond. The protocols and procedures for SL positioning are described, including the transmissions between UEs and the location management function (LMF) of the network.

The processes and systems described herein provide one or more of the following advantages. The angle based SL positioning processes described herein enable the determination of a physical location of a UE in the network based on several different approaches. The location of the UE refers to the coordinates of the UE in the network (e.g., with respect to one or more nodes) or absolute coordinates of the UE in space. A first approach enables the LMF of the network to determine a target UE location based on SL AoA positioning that uses an anchor UE. The processes enables the LMF to receive assistance data from the anchor UE. The LMF receives configuration data from the anchor UE and/or the target UE. The LMF sends data, responsive to a request, to the anchor UE and/or to the target UE. The anchor UE transfers AoA measurement results to the LMF. The LMF (and thus the network) therefore determine the location of the target UE. Each of these messages are subsequently described in detail.

A second approach enables the network to determine the location of a target UE based on a SL AoA positioning process in which the target UE performs the location calculation. The LMF or an anchor UE sends assistance data to the target UE. The anchor UE sends assistance data to the LMF. The anchor UE receives request data from the LMF. Each of these messages are subsequently described in detail.

A third approach enables the network to determine the location of a target UE based on a SL AoA positioning process in which the LMF performs the location calculation. The anchor UE sends assistance data to the LMF. The anchor UE sends configuration data to the LMF. Request information are sent from LMF to the anchor UE. The measurement results are transferred from the target UE to the LMF. Each of these messages are subsequently described in detail.

One or more advantages are enabled by the following embodiments.

In a general aspect, a method includes sending, from a network to an anchor user equipment (UE), a request for data describing a sidelink position reference signal (SL-PRS) transmission from a target UE to the anchor UE. The method includes receiving, at the network from the anchor UE, measurement results data comprising a measurement of a beam that is transmitted from the target UE to the anchor UE in the SL-PRS, the measurement results specifying an angle of arrival (AoA) of the beam that is measured at the anchor UE.

In some implementations, the method includes determining a location of the target UE with respect to a node of the network based on the measurement results data.

In some implementations, the method includes receiving assistance data from the anchor UE, the assistance data describing a synchronization source of the anchor UE, an identity of the anchor UE, or sidelink synchronization signal block (S-SSB) information for the anchor UE.

In some implementations, the method includes receiving configuration data from the anchor UE, the configuration data describing one or more SL-PRS resources used for the SL-PRS transmission, the one or more SL-PRS resources including a beam direction used by the target UE.

In some implementations, the measurement results further include a SL-PRS reference signal receive power (RSRP) for the beam.

In some implementations, the measurement results further include a SL-PRS reference signal received path power (RSRPP) for the beam.

In some implementations, the measurement results further include a SL-PRS time stamp and selected beam identifier for the measurement of the beam.

In some implementations, the AoA of the measurement results is based on a global coordinate system for the anchor UE, an angle of the global coordinate system being in relation to a geographic direction.

In some implementations, the AoA of the measurement results is based on a local coordinate system for the anchor UE, an angle of the local coordinate system being in relation to a previous position in the local coordinate system of the anchor UE, the local coordinate system being related to a global coordinate system by the anchor UE.

In some implementations, the AoA of the measurement results is based on a local coordinate system for the anchor UE, an angle of the local coordinate system being in relation to a configured SL-PRS beam direction.

In some implementations, the request for data describing the SL-PRS transmission requests one or more of i) a number of requested SL-PRS resource sets and SL-PRS resources per set, ii) spatial relation information that specifies the SL-PRS resource identifier, or iii) sidelink synchronization signal block (S-SSB) information associated with the SL-PRS.

In some implementations, a location of the anchor UE with respect to the node of the network is known.

In a general aspect, a method includes receiving, at a target user equipment (UE) from an anchor UE, a beam comprising a sidelink position reference signal (SL-PRS). The method includes measuring, at the target UE, an angle of arrival (AoA) of the beam of the SL-PRS. The method includes generating measurement results data specifying the measured AoA of the beam.

In some implementations, the method includes determining, at the target UE, a location of the target UE with respect to a node of a network based on the measurement results, the measurement results further specifying one or more other measured AoAs of respective other SL-PRSs from respective other anchor UEs.

In some implementations, the method includes receiving, at the target UE, assistance data from the anchor UE, the assistance data describing a synchronization source of the anchor UE, an identity of the anchor UE, or sidelink synchronization signal block (S-SSB) information for the anchor UE.

In some implementations, the measurement results further include a SL-PRS reference signal receive power (RSRP) for the beam.

In some implementations, the measurement results further include a SL-PRS reference signal received path power (RSRPP) for the beam.

In some implementations, the measurement results further include a SL-PRS time stamp and selected beam identifier for the measurement of the beam.

In some implementations, the AoA of the measurement results is based on a global coordinate system for the target UE, an angle of the global coordinate system being in relation to a geographic direction.

In some implementations, the AoA of the measurement results is based on a local coordinate system for the target UE, an angle of the local coordinate system being in relation to a previous position in the local coordinate system of the target UE, the local coordinate system being related to a global coordinate system by the target UE.

In some implementations, the AoA of the measurement results is based on a local coordinate system for the target UE, an angle of the local coordinate system being in relation to a configured SL-PRS beam direction.

In some implementations, the SL-PRS is received responsive to a request received at the anchor UE from a network, the request requesting data describing the SL-PRS transmission that include one or more of i) a number of requested SL-PRS resource sets and SL-PRS resources per set, ii) spatial relation information that specifies the SL-PRS resource identifier, or iii) sidelink synchronization signal block (S-SSB) information associated with the SL-PRS.

In some implementations, a location of the anchor UE with respect to the node of the network is known.

In a general aspect, a method includes sending, from a network to an anchor user equipment (UE), a request for data describing a sidelink position reference signal (SL-PRS) transmission from a target UE to the anchor UE; and receiving, at the network from the target UE, measurement results data comprising a measurement of a beam that is transmitted from the anchor UE to the target UE in the SL-PRS, the measurement results specifying an angle of arrival (AoA) of the beam that is measured at the target UE.

In some implementations, the method includes determining a location of the target UE with respect to a node of the network based on the measurement results data.

In some implementations, the method includes receiving assistance data from the anchor UE, the assistance data describing a synchronization source of the anchor UE, an identity of the anchor UE, or sidelink synchronization signal block (S-SSB) information for the anchor UE.

In some implementations, the method includes receiving configuration data from the anchor UE, the configuration data describing one or more SL-PRS resources used for the SL-PRS transmission, the one or more SL-PRS resources including a beam direction used by the anchor UE.

In some implementations, the measurement results further include a SL-PRS reference signal receive power (RSRP) for the beam.

In some implementations, the measurement results further include a SL-PRS reference signal received path power (RSRPP) for the beam.

In some implementations, the measurement results further include a SL-PRS time stamp and selected beam identifier for the measurement of the beam.

In some implementations, the AoA of the measurement results is based on a global coordinate system for the target UE, an angle of the global coordinate system being in relation to a geographic direction.

In some implementations, the AoA of the measurement results is based on a local coordinate system for the target UE, an angle of the local coordinate system being in relation to a previous position in the local coordinate system of the target UE, the local coordinate system being related to a global coordinate system by the target UE.

In some implementations, the AoA of the measurement results is based on a local coordinate system for the target UE, an angle of the local coordinate system being in relation to a configured SL-PRS beam direction.

In some implementations, the request for data describing the SL-PRS transmission requests one or more of i) a number of requested SL-PRS resource sets and SL-PRS resources per set, ii) spatial relation information that specifies the SL-PRS resource identifier, or iii) sidelink synchronization signal block (S-SSB) information associated with the SL-PRS.

In some implementations, a location of the anchor UE with respect to the node of the network is known.

A non-transitory computer storage medium encoded with instructions that, when executed by one or more computers, cause the one or more computers to perform operations previously described.

A system comprising one or more processors and one or more storage devices on which are stored instructions that are operable, when executed by the one or more computers, to cause the one or more computers to perform the methods previously described.

An apparatus comprising one or more baseband processors configured to perform operations previously described.

An apparatus comprising one or more baseband processors configured to perform the method previously described.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates an example communication system that includes sidelink communications, according to some implementations.

FIG. 2A illustrates an example of a network for uplink SL angle of arrival (SL-AoA) positioning.

FIG. 2B illustrates an example of a network for downlink SL angle of arrival (SL-AoA) positioning.

FIG. 3 illustrates an example environment for angle based sidelink positioning with an anchor UE.

FIG. 4 illustrates an example process for angle based sidelink positioning with an anchor UE.

FIG. 5 illustrates an example environment for angle based sidelink positioning with a target UE determination of the target UE location.

FIG. 6 illustrates an example process for angle based sidelink positioning with a target UE determination of the target UE location.

FIG. 7 illustrates an example process for angle based sidelink positioning with LMF calculation of the target UE location.

FIG. 8 illustrates a flowchart of an example method, according to some implementations.

FIG. 9 illustrates a flowchart of an example method, according to some implementations.

FIG. 10 illustrates a flowchart of an example method, according to some implementations.

FIG. 11 illustrates an example user equipment (UE), according to some implementations.

FIG. 12 illustrates an example access node, according to some implementations.

### DETAILED DESCRIPTION

Sidelink positioning is an objective in the positioning domain for NR telecommunications networks. This document describes a new sidelink angle of arrival (SL AoA) message for SL positioning. This documents describes interface and signaling configurations for preparing and transmitting the SL AoA messages for determining the location of a target UE in a NR network. Conventionally, in Uu communication links, an angle of arrival (AoA) is measured at a network node (e.g., gNB) for determining a location of a UE in the network relative to the node. This document describes several different processes for SL AoA messages in which the target UE location can be determined. In a first example, an anchor UE measures the AoA and LMF determines the location of the target UE based on the anchor UE's measurements. In a second example process, the target UE measures AoA values for transmissions from anchor UE(s) and/or the node and determines a location of the target UE. An anchor UE includes a UE for which the location in the network is known. In a third example process, the network, by the location management function (LMF), determines the location of the target UE based on the AoA measurements from one or more anchor UEs and the target UE. The example interfaces between the UEs and the LMF are described herein.

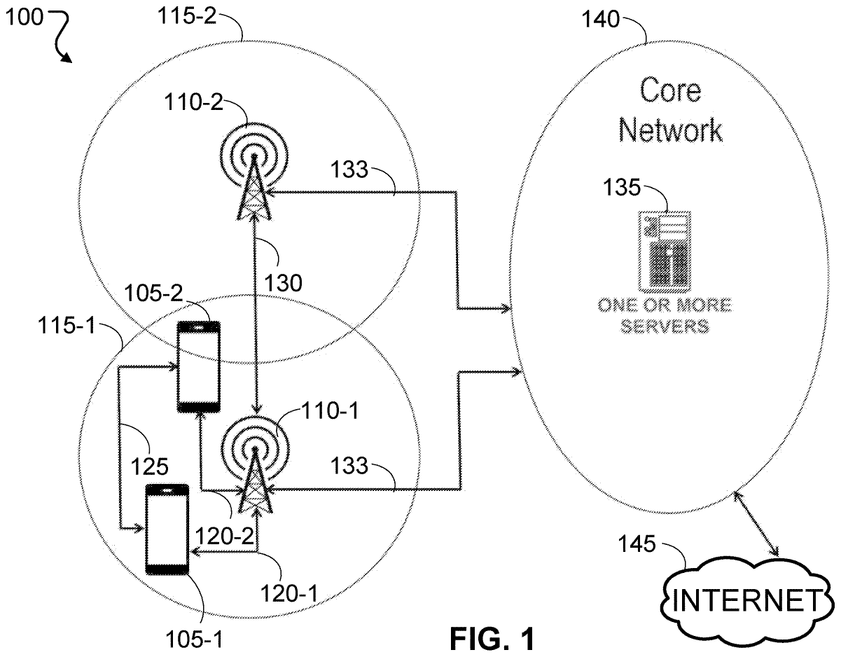

FIG. 1 illustrates an example communication system 100 that includes sidelink communications, according to some implementations. It is noted that the system of FIG. 1 is merely one example of a possible system, and that features of this disclosure may be implemented in other wireless communication systems.

The following description is provided for an example communication system that operates in conjunction with fifth generation (5G) networks as provided by 3GPP technical specifications. However, the example implementations are not limited in this regard and the described examples may apply to other networks that may benefit from the principles described herein, such as 3GPP Long Term Evolution (LTE) networks, Wi-Fi or Worldwide Interoperability for Microwave Access (WiMax) networks, and the like. Furthermore, other types of communication standards are possible, including future 3GPP systems (e.g., Sixth Generation (6G)), IEEE 802.16 protocols, or the like. While aspects may be described herein using terminology commonly associated with 5G NR, aspects of the present disclosure can be applied to other systems, such as 3G, 4G, and/or systems subsequent to 5G (e.g., 6G).

Frequency bands for 5G NR may be separated into two different frequency ranges. Frequency Range 1 (FR1) may include frequency bands operating in sub-6 GHz frequencies, some of which are bands that may be used by previous standards and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1.

As shown, the communication system 100 includes a number of user devices. More specifically, the communication system 100 includes two UEs 105 (UE 105-1 and UE 105-2 are collectively referred to as “UE 105” or “UEs 105”), two base stations 110 (base station 110-1 and base station 110-2 are collectively referred to as “base station 110” or “base stations 110”), two cells 115 (cell 115-1 and cell 115-2 are collectively referred to as “cell 115” or “cells 115”), and one or more servers 135 in a core network (CN) 140 that is connected to the Internet 145.

In some implementations, the UEs 105 can directly communicate with base stations 110 via links 120 (link 120-1 and link 120-2 are collectively referred to as “link 120” or “links 120”), which utilize a direct interface with the base stations referred to as a “Uu interface.” Each of the links 120 can represent one or more channels. The links 120 are illustrated as an air interface to enable communicative coupling, and can be consistent with cellular communication protocols, such as a GSM protocol, a CDMA network protocol, a UMTS protocol, a 3GPP LTE protocol, an Advanced long term evolution (LTE-A) protocol, an LTE-based access to unlicensed spectrum (LTE-U), a 5G protocol, a NR protocol, an NR-based access to unlicensed spectrum (NR-U) protocol, and/or any of the other communications protocols discussed herein.

As shown, certain user devices may be able to conduct communications with one another directly, e.g., without an intermediary infrastructure device such as base station 110-1. In this example, UE 105-1 may conduct communications directly with UE 105-2. Similarly, the UE 105-2 may conduct communications directly with UE 105-1. Such peer-to-peer communications may utilize a “sidelink” interface such as a PC5 interface. In certain implementations, the PC5 interface supports direct cellular communication between user devices (e.g., between UEs 105), while the Uu interface supports cellular communications with infrastructure devices such as base stations. For example, the UEs 105 may use the PC5 interface for a radio resource control (RRC) signaling exchange between the UEs (also called PC5-RRC signaling). The PC5/Uu interfaces are used only as an example, and PC5 as used herein may represent various other possible wireless communications technologies that allow for direct sidelink communications between user devices, while Uu in turn may represent cellular communications conducted between user devices and infrastructure devices, such as base stations.

In some implementations, the UEs 105 may be configured with parameters for communicating via the Uu interface and/or the sidelink interface. In some examples, the UEs 105 may be “pre-configured” with some parameters. In these examples, the parameters may be hardwired into the UEs 105 or coded into spec. Additionally and/or alternatively, the UEs 105 may receive the parameters from the one or more of the base stations 110.

To transmit/receive data to/from one or more base stations 110 or UEs 105, the UEs 105 may include a transmitter/receiver (or alternatively, a transceiver), memory, one or more processors, and/or other like components that enable the UEs 105 to operate in accordance with one or more wireless communications protocols and/or one or more cellular communications protocols. The UEs 105 may have multiple antenna elements that enable the UEs 105 to maintain multiple links 120 and/or sidelinks 125 to transmit/receive data to/from multiple base stations 110 and/or multiple UEs 105. For example, as shown in FIG. 1, UE 105-1 may connect with base station 110-1 via link 120 and simultaneously connect with UE 105-2 via sidelink 125.

In some implementations, one or more sidelink radio bearers may be established on the sidelink 125. The sidelink radio bearers can include signaling radio bearers (SL-SRB) and/or data radio bearers (SL-DRB).

The PC5 interface may alternatively be referred to as a sidelink interface and may include one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), Physical Sidelink Feedback Channel (PSFCH), and/or any other like communications channels. The PSFCH carries feedback related to the successful or failed reception of a sidelink transmission. The PSSCH can be scheduled by sidelink control information (SCI) carried in the sidelink PSCCH. In some examples, the sidelink interface can operate on an unlicensed spectrum (e.g., in the unlicensed 5 Gigahertz (GHz) and 6 GHz bands) or a (licensed) shared spectrum.

In one example, the sidelink interface implements vehicle-to-everything (V2X) communications. The V2X communications may, for example, adhere to 3GPP Cellular V2X (C-V2X) specifications, or to one or more other or subsequent standards whereby vehicles and other devices and network entities may communicate. V2X communications may utilize both long-range (e.g., cellular) communications as well as short-to medium-range (e.g., non-cellular) communications. Cellular-capable V2X communications may be called Cellular V2X (C-V2X) communications. C-V2X systems may use various cellular radio access technologies (RATs), such as 4G LTE or 5G NR RATs (or RATs subsequent to 5G, e.g., 6G RATs). Certain LTE standards usable in V2X systems may be called LTE-Vehicle (LTE-V) standards. As used herein in the context of V2X systems, and as defined above, the term “user devices” may refer generally to devices that are associated with mobile actors or traffic participants in the V2X system, e.g., mobile (able-to-move) communication devices such as vehicles, pedestrian user equipment (PUE) devices, and roadside units (RSUs).

In some implementations, UEs 105 may be physical hardware devices capable of running one or more applications, capable of accessing network services via one or more radio links 120 with a corresponding base station 110 (also referred to as a “serving” base station), and capable of communicating with one another via sidelink 125. Link 120 may allow the UEs 105 to transmit and receive data from the base station 110 that provides the link 120. The sidelink 125 may allow the UEs 105 to transmit and receive data from one another. The sidelink 125 between the UEs 105 may include one or more channels for transmitting information from UE 105-1 to UE 105-2 and vice versa and/or between UEs 105 and UE-type RSUs and vice versa.

In some implementations, the base stations 110 are capable of communicating with one another over a backhaul connection 130 and may communicate with the one or more servers 135 within the CN 140 over another backhaul connection 133. The backhaul connections can be wired and/or wireless connections.

In some implementations, the UEs 105 are configured to use a resource pool for sidelink communications. A sidelink resource pool defines the time-frequency resources used for sidelink communications, and may be divided into multiple time slots, frequency channels, and frequency sub-channels. In some examples, the UEs 105 are synchronized and perform sidelink transmissions aligned with slot boundaries. A UE may be expected to select several slots and sub-channels for transmission of the transport block. In some examples, a UE may use different sub-channels for transmission of the transport block across multiple slots within its own resource selection window.

In some implementations, an exceptional resource pool may be configured for the UEs 105, perhaps by the base stations 110. The exceptional resource pool includes resources that the UEs 105 can use in exceptional cases, such as Radio Link Failure (RLF). The exceptional resource pool may include resources selected based on a random allocation of resources.

In some implementations, a UE that is initiating a communication with another UE is referred to as a transmitter UE (TX UE), and the UE receiving the communication is referred to as a receiver UE (RX UE). For example, UE 105-1 may be a TX UE and UE 105-2 may be an RX UE. Although FIG. 1 illustrates a single TX UE communicating with a single RX UE, a TX UE may communicate with more than one RX UE via sidelink.

In some implementations, a TX UE that is initiating sidelink communication may determine the available resources (e.g., sidelink resources) and may select a subset of these resources to communicate with an RX UE based on a resource allocation scheme. Example resource allocation schemes include Mode 1 and Mode 2 resource allocation schemes. In Mode 1 resource allocation scheme (referred to as “Mode 1”), the resources are allocated by a network node for in-coverage UEs. In Mode 2 resource allocation scheme (referred to as “Mode 2”), the TX UE selects the sidelink resources (e.g., sidelink transmission resources).

In some implementations, the communication system 100 supports different cast types, including unicast, broadcast, and groupcast (or multicast) communications. Unicast refers to direction communications between two UEs. Broadcast refers to a communication that is broadcast by a single UE to a plurality of other UEs. Groupcast refers to communications that are sent from a single UE to a set of UEs that satisfy a certain condition (e.g., being a member of a particular group).

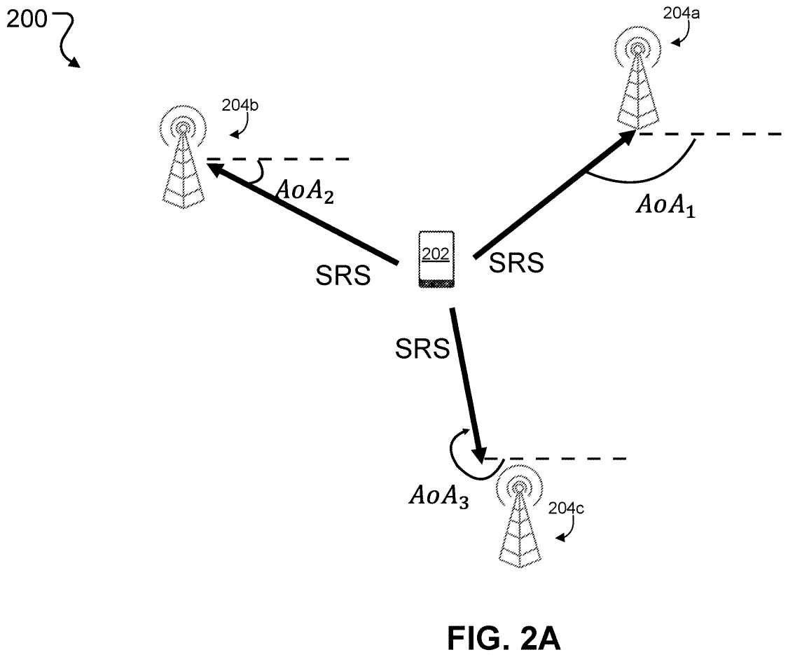

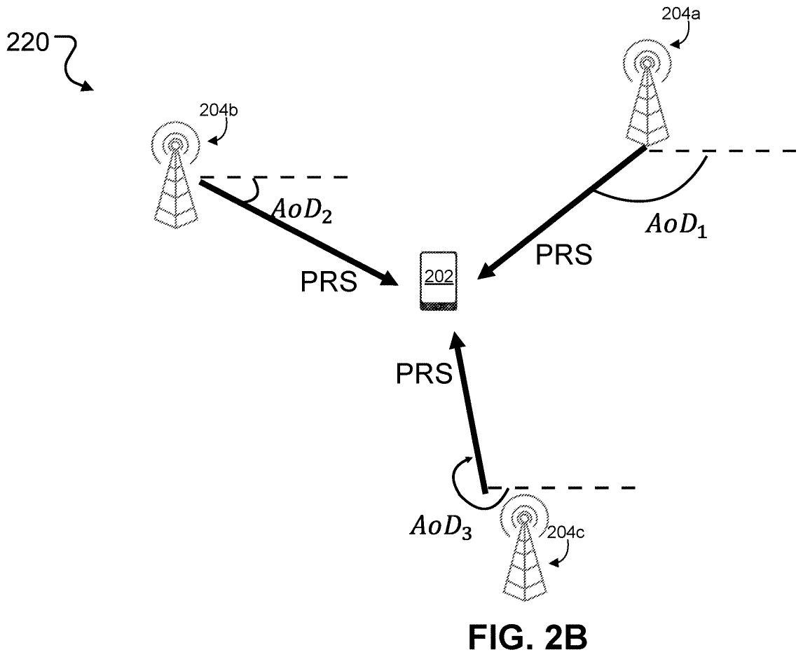

FIG. 2A illustrates an example of an environment 200 for uplink SL angle of arrival (SL-AoA) positioning. Specifically, network 200 shows an example Uu link in which the UL angle of arrival (UL AoA) is determined. A target UE 202 sends sounding reference signals (SRSs) to a set of base stations 204a, 204b, and 204c. Each of the base stations 204a-c measures a respective AoA of the SRS, generating respective measurements AoA₁, AoA₂, and AoA₃. The base stations 204a-c report the measured AoA values AoA₁, AoA₂, and AoA₃ to the LMF. Based on the locations of the base stations 204a-c, the LMF calculates the location of the target UE 202. The UL-AoA positioning method makes use of the measured azimuth and zenith of arrival at multiple receive points (RPs) of uplink signals transmitted from the UE. The RPs measure azimuth AoA (A-AoA) and zenith AoA (Z-AoA) of the received signals based on assistance data received from the positioning server. The node uses the assistance data and the resulting measurements, along with other configuration information, to estimate the location of the UE.

FIG. 2B illustrates an example of an environment 220 for downlink SL angle of arrival (SL-AoA) positioning. Specifically, environment 220 shows a Uu link in which angles of departure (AoD) are determined. The base stations 204a-c send respective position reference signals (PRSs) to the target UE 202. Each base station 204a-c measures a respective angle of departure AoD₁, AoD₂, and AoD₃ for the signal sent to the target UE 202. The DL-AoD positioning method makes use of the measured DL-PRS-RSRP of downlink signals received from multiple transmission points (TPs) at the UE. The UE measures the DL-PRS-RSRP of the received signals using assistance data received from the positioning server, and the resulting measurements are used along with other configuration information to locate the UE in relation to the neighboring TPs.

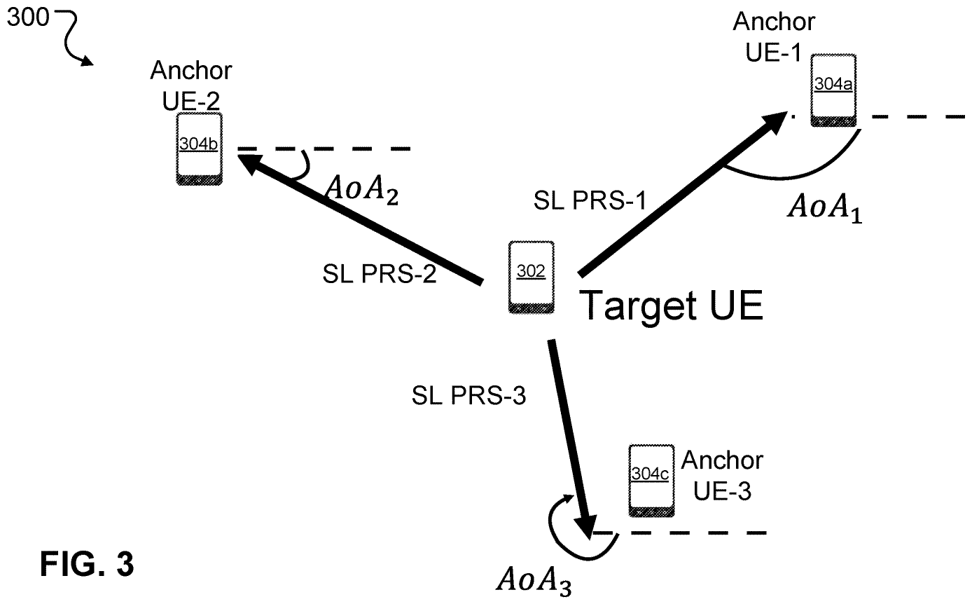

FIG. 3 illustrates an example of an environment 300 for angle based sidelink positioning with anchor UE(s). The environment includes a target UE 302 and a set of anchor UEs 304a, 304b, and 304c. Each of the anchor UEs 304a-c is configured to receive a sidelink PRS (SL-PRS) signal from the target UE 302. In contrast with the Uu link of FIG. 2A, the sidelink transmissions do not include nodes or base stations but the anchor UEs 304a-c. The anchor UEs 304a-c are each configured to measure a respective AoA value for the SL-PRS transmission from the target UE 302. The anchor UE₁ 304a measures AoA₁ of the SL-PRS₁ from the target UE 302. The anchor UE₂ 304b measures AoA₂ of the SL-PRS₂ from the target UE 302. The anchor UE₃ 304c measures AoA₃ of the SL-PRS₃ from the target UE 302.

This environment 300 includes signaling that specifies assistance data that are transmitted from the anchor UEs 304a-c to the LMF. This environment 300 includes configuration data being transmitted from the anchor UEs 304a-c and/or the target UE 302 to the LMF. This environment 300 includes measurement results being transmitted from the anchor UEs 304a-c to the LMF. Each of these messages are subsequently described.

Each anchor UE 304a-c generates assistance data to assist the LMF for determining the location of the target UE 302. The assistance data are associated with a corresponding AoA measurement by a given anchor UE 304a-c. In environment 300, the LMF performs the determination or calculation of the location of the target UE 302 based on the AoA₁, AoA₂, and AoA₃ values measured by the respective anchor UEs 304a-c. Each of the anchor UEs 304a-c sends a respective measured AoA value and corresponding assistance data to the LMF for the calculation. The assistance data sent with the measured AoA value from each anchor UE 304a-c assists the LMF for determining the location of the target UE 302.

The assistance data sent by each anchor UE 304a-c can include particular data for anchor UE based SL AoA positioning. The assistance data are sent from each anchor UE 304a-c to the LMF. The assistance data include an identifier of the anchor UE's identifier, which can include the subscriber identity module identifier (TSIM)). The assistance data can include a geo-location of the respective anchor UE 304a-c. The assistance data can specify the synchronization source of the synchronization signal identifier (SSID). For example, the anchor UE can be using the global navigation satellite system (GNSS) as the synchronization source. In another example, the anchor UE can be using the gNB or network as a synchronization source. The assistance data can include the sidelink synchronization signal block (S-SSB) information. The S-SSB information describes the synchronization source.

Each anchor UE 304a-c and/or the target UE 302 sends configuration data to the LMF for anchor UE based SL AoA positioning. Anchor UE(s) 304a-c or the target UE 302 is configured to describe, to the LMF (and the network), the configuration of the SL-PRS signals being transmitted between the target UE 302 and each of the anchor UEs 304a-c. The confirmation data specifies the configuration of each SL-PRS signal being sent by the target UE 302 to a respective anchor UE 304a-c. For example, the SL-PRS configuration can include the SL-PRS resources being used for the transmission such as beam direction that are used by the target UE 302 for each SL-PRS signal.

The LMF sends request information to each of the anchor UEs 304a-c and/or the target UE 302. The request information requests, from each anchor UE 304a-c, data describing the SL-PRS transmission between the target UE 302 and the respective anchor UE 304a-c. The request data requests data describing a number of transmissions and their respective durations for each SL-PRS transmission. The LMF requests, from the anchor UEs 304a-c or the target UE 302, a bandwidth being used for each SL-PRS. Generally, a larger bandwidth enables a more accurate AoA measurement at the anchor UE 304a-c. The LMF requests, from the anchor UEs 304a-c or the target UE 302, a resource type for the SL-PRS signals. Resource types can include to periodic resources, aperiodic resources, or semi-persistent resources. The LMF requests, from the anchor UEs 304a-c or the target UE 302, a data describing the number of requested SL-PRS resource sets and SL-PRS resources per set. The LMF requests, from the anchor UEs 304a-c or the target UE 302, spatial relation information that specifies the SL-PRS resource identifier. The LMF requests, from the anchor UEs 304a-c or the target UE, S-SSB information associated with the SL-PRS.

The anchor UEs 304a-c are configured to measure AoA for the SL-PRS signals, and each anchor UE 304a-c is configured to transfer the measurement results to the LMF. The measurements include the SL-PRS reference signal receive power (RSRP). The measurements can include SL-PRS reference signal received path power (RSRPP). The measurement results are associated with results data that specifies the SL-PRS resources used in the measurement for each anchor UE 304a-c. The measurement results data specify a time stamp and beam information for each measurement.

The results data can include angle information of the anchor UE 304a-c at the time of each measurement. This is because the anchor UE 304a-c can be rotated at the time of arrival of the SL-PRS. The angle is considered for the AoA determination for a respective anchor UE 304a-c. In a first example, an anchor UE's 304a-c angle is reported as a value for a global coordinate system. The angle can be the anchor UE's 304a-c angle to a reference geographical direction (geographic north). The global coordinate system could be either based on an earth center or based on a sun center, and so forth. In another example, the anchor UE's 304a-c angle is reported as a value for a local coordinate system. For example, the local coordinates for the local coordinate system can be with respect to a top of the anchor UE physical structure (e.g., a top of the phone). In this example, the local coordinate system can be related to a global coordinate system. For example, at each measurement, the reference coordinate system related to global coordinate system is reported. For example, the AoA can be reported as 45°with respect to a face or top of the UE chassis, and the UE chassis is then determined to be at a specific angle with respect to a north direction. In another example, at each measurement, the reference coordinate system related to the previous reported reference coordinate system is reported. In this example, the change in angle from a previous measurement is reported in the AoA measurement. The LMF determines the AoA with respect to a global coordinate system (or the true location of the anchor UE 304a-c and therefore the target UE 302) by back-calculating the AoA based on this difference. In another example, the anchor UE 304a-c measures the anchor UE's angle with respect to a reference direction corresponding to a configured SL-PRS beam direction. In this example, the beam direction is specified (e.g., in the assistance data). If the anchor UE rotates during a measurement reporting period, then the anchor UE's reports are either based on only a single measurement during the measurement reporting period or multiple measurements are reported for the measurement reporting period. The measured or reported angles can be in various units. For example, the angles can be reported as azimuth angles, or zenith angles, or both can be reported.

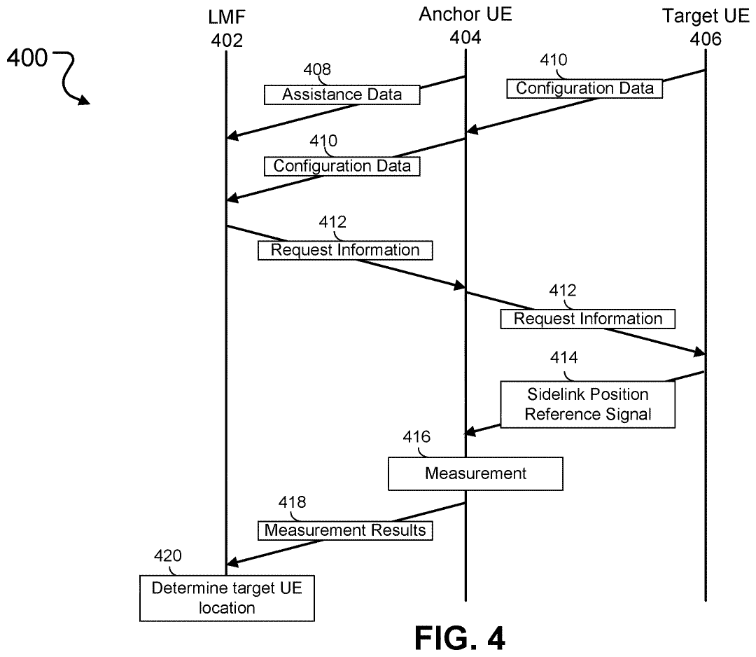

FIG. 4 illustrates an example process 400 for angle based sidelink positioning with an anchor UE 404. The anchor UE 404 can include one of anchor UEs 304a-c of FIG. 3. A target UE 406 can include target UE 302 of FIG. 3. The location management function (LMF) 402 is a part of the network, as previously described. The LMF 402, anchor UE 404, and target UE 406 can operate in environment 300 described in relation to FIG. 3.

The anchor UE 404 sends assistance data 408 to the LMF 402. The assistance data describes how the anchor UE 404 performs the AoA measurement of the SL-PRS transmission from the target UE 406, as described in relation to FIG. 3. The target UE 406 sends configuration data 410 to the anchor UE 404. The configuration data 410 describes the SL-PRS signal, as described previously in relation to FIG. 3. This configuration data 410 are passed from the anchor UE 404 to the LMF 402 for performing the determination of the target UE 406 location.

The LMF 402 sends request information 412 to the anchor UE 404. The request information 412, described in relation to FIG. 3, includes requests, from each anchor UE 404, data describing the SL-PRS transmission from the target UE 406 to the respective anchor UE 404. The request data requests data describing a number of transmissions and their respective durations for each SL-PRS transmission, as described previously. The request information 412 is forwarded to the target UE 406 by the anchor UE 404.

The target UE 406 sends a SL-PRS 414 to the anchor UE 404. The SL-PRS is sent in accordance with the configuration data 410 previously transmitted to the anchor UE 404. The anchor UE 404 performs an AoA measurement 416 of the SL-PRS 414 from the target UE 406. The anchor UE 404 performs the measurement 416 in accordance with the parameters of the assistance data 408 sent to the LMF 402 by the anchor UE 404. The anchor UE 404 sends the measurement results 418 to the LMF 402. The LMF determines the target UE location 420 based on the measurement results 418 from each anchor UE 404. Though one anchor UE 404 is shown for process 400, portions of the process 400 are replicated for each of the anchor UEs 304a-c of environment 300 of FIG. 3. For example, each anchor UE 304a-c sends assistance data 408, configuration data 410, receives a SL-PRS 414, performs a measurement 416, and sends respective measurement results 418 to the LMF 402 for determining the location 420 of the target UE 406.

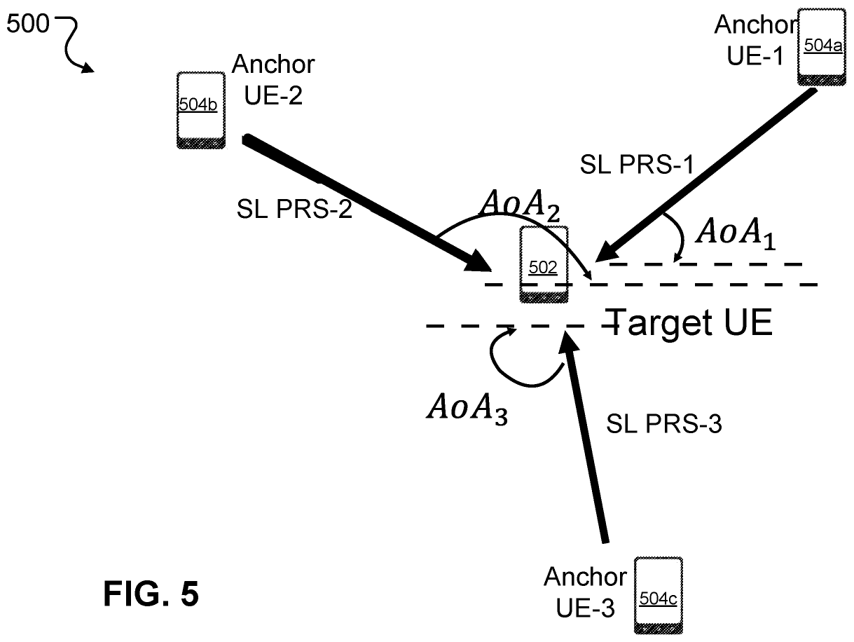

FIG. 5 illustrates an example of an environment 500 for angle based sidelink positioning with a target UE determination of the target UE location. The environment includes a target UE 502 and a set of anchor UEs 504a, 504b, and 504c. Each of the anchor UEs 504a-c is configured to transmit a sidelink PRS (SL-PRS) signal to the target UE 502. In contrast with the Uu link of FIG. 2B, the sidelink transmissions do not include nodes or base stations but the anchor UEs 504a-c. The target UE is configured to measure a respective AoA value for each corresponding SL-PRS transmission from a respective anchor UE 504a-c. The target UE 502 measures AoA₁ of the SL-PRS₁ from the anchor UE₁ 504a. The target UE 502 measures AoA₂ of the SL-PRS₂ from the anchor UE₂ 504b. The target UE 502 measures AoAs of the SL-PRS₃ from the anchor UE₃ 504c. This environment 500 includes signaling that specifies assistance data that are transmitted from the anchor UEs 504a-c and/or the LMF to the target UE 502. This environment 500 includes signaling that specifies assistance data that are transmitted from the anchor UEs 504a-c to the LMF. This environment 500 includes request information being transmitted from the LMF to the anchor UEs 504a-c. Each of these messages are subsequently described.

The target UE 502 performs the calculation for the target UE based sidelink AoA positioning. The anchor UEs 504a-c or the LMF send assistance data to the target UE. The assistance data are associated with a corresponding AoA measurement by the target UE 502 for each SL-PRS signal received from the corresponding anchor UE 504a-c. In environment 500, the target UE 502 performs determination or calculation of the location of the target UE 502 based on the AoA₁, AoA₂, and AoA₃ values measured by the target UE 502 and associated with respective assistance data.

The assistance data sent by each anchor UE 504a-c can include particular data for target UE based SL AoA positioning. The assistance data are sent from each anchor UE 504a-c or the LMF (via the anchor UEs 504a-c) to the target UE 502. The assistance data can include the synchronization signal identifier (SSID) associated with the SL-PRS transmission from each anchor UE 504a-c. The assistance data can specify the synchronization source for the anchor UE 504a-c. For example, the anchor UE 504a-c can be using the global navigation satellite system (GNSS) as the synchronization source. In another example, the anchor UE 504a-c can be using the gNB or network as a synchronization source. In some implementations, the anchor UEs 504a-c can be using different synchronization sources. The assistance data can include the sidelink synchronization signal block (S-SSB) information. The S-SSB information describes the synchronization source. The assistance data includes SL-PRS configuration of each anchor UE. This SL-PRS configuration includes SL-PRS resources including beam direction and other information. The assistance data can include a geo-location of the respective anchor UE 504a-c.

The assistance data can include angle information of the anchor UE 504a-c at the time of each SL-PRS transmission from the respective anchor UE. For example, the angle can represent the anchor UE's 504a-c angle in a global coordinate system. For example, the global angle can be the anchor UE's 504a-c angle to a reference geographical direction (geographic north). The global coordinate system can be either based on an Earth center, a sun center, and so forth. The angle can represent the anchor UE's 504a-c angle in local coordinate system, such as with respect to a top of the UE chassis or other point of reference. For example, at each measurement, the reference coordinate system is related to a global coordinate system and the relation is reported by the anchor UE 504a-c. In another example, at each measurement, coordinates for a reference (local) coordinate system are related to previous reported coordinates of a reference coordinate system, and this relation is reported. In another example, the anchor UE's 504a-c angle with respect to a reference direction corresponding to a configured SL-PRS beam direction is measured and reported. If target UE rotates during a measurement period, then the target UE uses only a single measurement during the measurement period. The angles can be reported as azimuth angles, or zenith angles, or both angles can be reported.

The anchor UE 504a-c sends the assistance data to the LMF. The assistance data can include the synchronization signal identifier (SSID) associated with the SL-PRS transmission from each anchor UE 504a-c. The assistance data can specify the synchronization source for the anchor UE 504a-c. For example, the anchor UE 504a-c can be using the global navigation satellite system (GNSS) as the synchronization source. In another example, the anchor UE 504a-c can be using the gNB or network as a synchronization source. In some implementations, the anchor UEs 504a-c can be using different synchronization sources. The assistance data can include the sidelink synchronization signal block (S-SSB) information. The S-SSB information describes the synchronization source. The assistance data can include a geo-location of the respective anchor UE 504a-c.

The LMF sends request information to the anchor UEs 504a-c. The request data requests data describing a number of transmissions and their respective durations for each SL-PRS transmission. The LMF requests, from the anchor UEs 504a-c or the target UE 502, a bandwidth being used for each SL-PRS. Generally, a larger bandwidth enables a more accurate AoA measurement at the anchor UE 504a-c. The LMF requests, from the anchor UEs 304a-c or the target UE 302, a resource type for the SL-PRS signals. Resource types include periodic SL-PRS resources, aperiodic SL-PRS resources, and semi-persistent SL-PRS resources. The LMF requests, from the anchor UEs 504a-c or the target UE 502, a data describing the number of requested SL-PRS resource sets and SL-PRS resources per set. The LMF requests, from the anchor UEs 504a-c or the target UE 502, spatial relation information that specifies the SL-PRS resource identifier. Assistance data transmission from the anchor UEs 504a-c to the LMF may be triggered by a request from LMF. The assistance data transmission from the LMF to the target UE 502 may be triggered by a request from target UE.

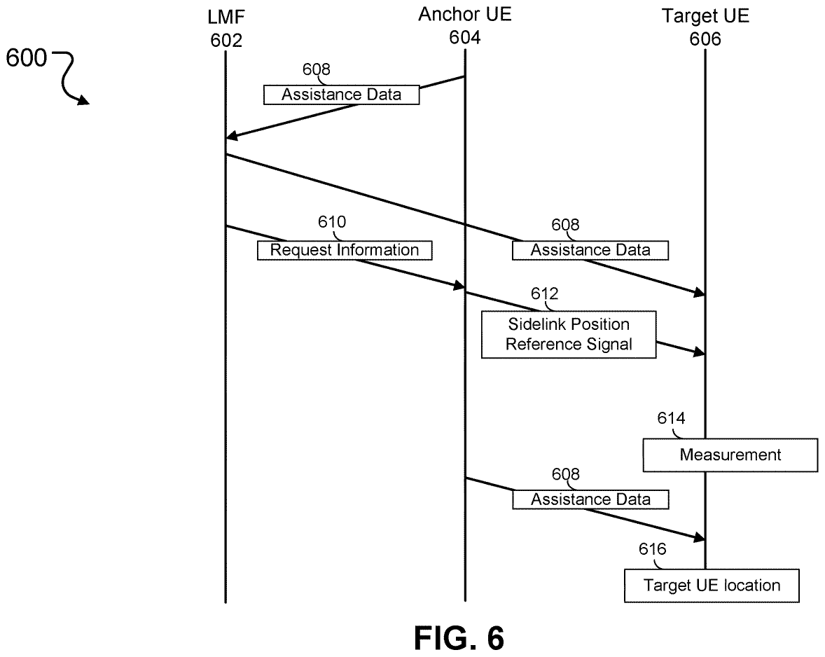

FIG. 6 illustrates an example process 600 for angle based sidelink positioning with a target UE determination of the target UE location. The anchor UE 604 can include one of anchor UEs 504a-c of FIG. 5. A target UE 606 can include target UE 502 of FIG. 5. The location management function (LMF) 602 is a part of the network, as previously described. The LMF 602, anchor UE 604, and target UE 606 can operate in environment 500 described in relation to FIG. 5.

The anchor UE 604 or LMF 602 sends assistance data 608 to the LMF 602. The assistance data describes how the target UE 606 performs the AoA measurement of the SL-PRS transmission from the anchor UE 606, as described in relation to FIG. 5. The assistance data can specify the synchronization source for the anchor UE 504a-c. For example, the anchor UE 504a-c can be using the global navigation satellite system (GNSS) as the synchronization source. In another example, the anchor UE 504a-c can be using the gNB or network as a synchronization source. In some implementations, the anchor UEs 504a-c can be using different synchronization sources. The assistance data can include the sidelink synchronization signal block (S-SSB) information. The S-SSB information describes the synchronization source. The assistance data can include a geo-location of the respective anchor UE 504a-c.

The LMF 602 sends request information 610 to the anchor UE 604. The request information 612, described in relation to FIG. 5, includes requests, from the target UE 606, data describing the SL-PRS transmission from the anchor UE 604 to the respective anchor UE 604. The request data requests data describing a number of transmissions and their respective durations for each SL-PRS transmission, as described previously. The anchor UE can send the response to the LMF.

The anchor UE 604 sends a SL-PRS 612 to the target UE 606. The SL-PRS is sent in accordance with the configuration data 410 previously transmitted to the target UE 606. In some implementations, the assistance data include the configuration data, as shown in FIG. 6. The target UE 606 performs an AoA measurement 614 of the SL-PRS 612 from the anchor UE 604. The target UE 604 performs the measurement 614 in accordance with the parameters of the assistance data 608 sent to the target UE 606 by the anchor UE 604. The target UE 606 determines the target UE location 616 based on measurement results from the AoA measurement 614 of the SL-PRS from each anchor UE 604 and the assistance data 608. Though one anchor UE 604 is shown for process 600, portions of the process 600 are replicated for each of the anchor UEs 504a-c of environment 500 of FIG. 5. For example, each anchor UE 504a-c sends assistance data 608 and transmits a SL-PRS 612. In some implementations, the target UE 606 can transmit the determined location 616 of the target UE to the LMF 602, anchor UE 604, or any other device as needed. If target UE rotates during a measurement reporting period, then the UE's reports are either based on a single measurement during the measurement reporting period, or multiple measurements are reported for the measurement reporting period.

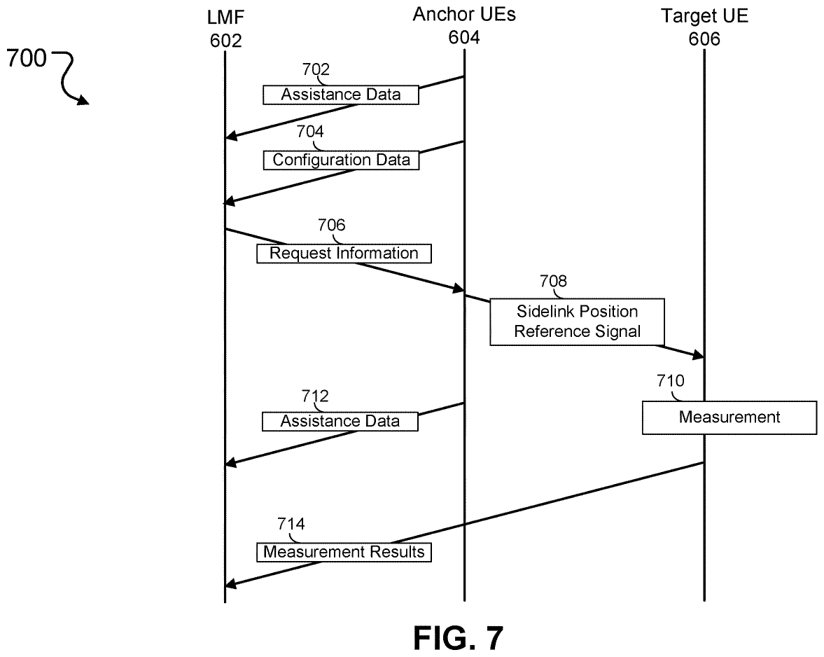

FIG. 7 illustrates an example process 700 for angle based sidelink positioning with LMF calculation of the target UE location. The anchor UE(s) 604 can include one of anchor UEs 504a-c of FIG. 5. A target UE 606 can include target UE 502 of FIG. 5. The location management function (LMF) 602 is a part of the network, as previously described. The LMF 602, anchor UE 604, and target UE 606 can operate in environment 500 described in relation to FIG. 5.

The assistance data 702 are sent from each anchor UE 604 to the LMF 602. The assistance data 702 include an identifier of the anchor UE's identifier, which can include the subscriber identity module identifier (TSIM)). The assistance data 702 can include a geo-location of the respective anchor UE 604. The assistance data 702 can specify the synchronization source of the synchronization signal identifier (SSID). For example, the anchor UE 604 can be using the global navigation satellite system (GNSS) as the synchronization source. In another example, the anchor UE can be using the gNB or network as a synchronization source. The assistance data 702 can include the sidelink synchronization signal block (S-SSB) information. The S-SSB information describes the synchronization source. The assistance data 702 can include Angle information of the anchor UE at the time of each SL-PRS transmission.

Each anchor UE 604 sends configuration data 704 to the LMF 602 and/or to the target UE for anchor UE based SL AoA positioning. Anchor UE(s) 604 is configured to describe, to the LMF 602 and/or to the target UE, the configuration of the SL-PRS signals being transmitted by the anchor UEs 604 to the target UE 606. The confirmation data 704 specifies the configuration of each SL-PRS signal being sent by the anchor UEs 604 to the target UE 606. For example, the SL-PRS configuration can include the SL-PRS resources being used for the transmission such as beam direction that are used by the anchor UEs 604 for each SL-PRS signal.

The LMF 602 sends request information 706 to the anchor UEs 604. The request data requests data describing a number of transmissions and their respective durations for each SL-PRS transmission. The LMF 602 requests, from the anchor UEs 604, a bandwidth being used for each SL-PRS. Generally, a larger bandwidth enables a more accurate AoA measurement at the anchor UE 604. The LMF 602 requests, from the anchor UEs 604, a resource type for the SL-PRS signals. Examples of resources include periodic SL-PRS resource, aperiodic SL-PRS resources and semi-persistence SL-RPS resources. The LMF 602 requests, from the anchor UEs 604, a data describing the number of requested SL-PRS resource sets and SL-PRS resources per set. The LMF 604 requests, from the anchor UEs 604, spatial relation information that specifies the SL-PRS resource identifier.

The anchor UE 604 sends a SL-PRS 708 to the target UE 606. Each of the anchor UEs 604 sends a respective SL-PRS 608. Though one anchor UE 604 is shown for process 700, portions of the process 700 are replicated for each of the anchor UEs 504a-c of environment 500 of FIG. 5. For example, each anchor UE 504a-c sends assistance data 702 and configuration data 704 to the LMF 602 and transmits a SL-PRS 708 to the anchor UE 606.

The target UE 606 is configured to perform a measurement 710 of the AoA for the SL-PRS signals 708 received from the anchor UEs 604. The target UE 606 is configured to transfer the measurement results 714 to the LMF 602 (e.g., directly or via the anchor UE 604). The measurements 710 include the SL-PRS reference signal receive power (RSRP). The measurements 710 can include SL-PRS reference signal received path power (RSRPP). The measurement results 714 are associated with results data that specifies the SL-PRS resources used in the measurement 710 for the target UE 606. The measurement results data 714 specify a time stamp and beam information for each measurement.

The results data 714 can include angle information of the target UE 606 at the time of each measurement. This is because the target UE 606 can be rotated at the time of arrival of the SL-PRS. The angle is considered for the AoA determination for a respective anchor UE 604. In a first example, the AoA for the target UE 606 for a given SL-PRS signal from an anchor UE 604 is reported as a value for a global coordinate system. The angle can be the target UE's 606 angle to a reference geographical direction (geographic north). The global coordinate system could be either based on an earth center or based on a sun center, and so forth. In another example, the target UE's 606 angle is reported as a value for a local coordinate system. For example, the local coordinates for the local coordinate system can be with respect to a top of the target UE physical structure (e.g., a top of the phone). In this example, the local coordinate system can be related to a global coordinate system. For example, at each measurement, the reference coordinate system related to global coordinate system is reported. For example, the AoA can be reported as 45° with respect to a face or top of the target UE 606 chassis, and the target UE 606 chassis is then determined to be at a specific angle with respect to a north direction. In another example, at each measurement, the reference coordinate system related to the previous reported reference coordinate system is reported. In this example, the change in angle from a previous measurement is reported in the AoA measurement. The LMF 602 determines the AoA with respect to a global coordinate system (or the true location of the target UE 606) by back-calculating the AoA based on this difference. In another example, the target UE 606 measures the target UE's angle with respect to a reference direction corresponding to a configured SL-PRS beam direction from an anchor UE 604. In this example, the beam direction is specified (e.g., in the assistance data). The measured or reported angles can be in various units. For example, the angles can be reported as azimuth angles, or zenith angles, or both can be reported.

The anchor UEs 604 can report, to the LMF 602, assistance data associated with respective SL-PRS signals transmitted to the target UE 606 and measured by the target UE 606 for AoA position determination. The assistance data is previously described. The assistance data transmission from the anchor UEs 604 to LMF 602 may be triggered by a request from the LMF.

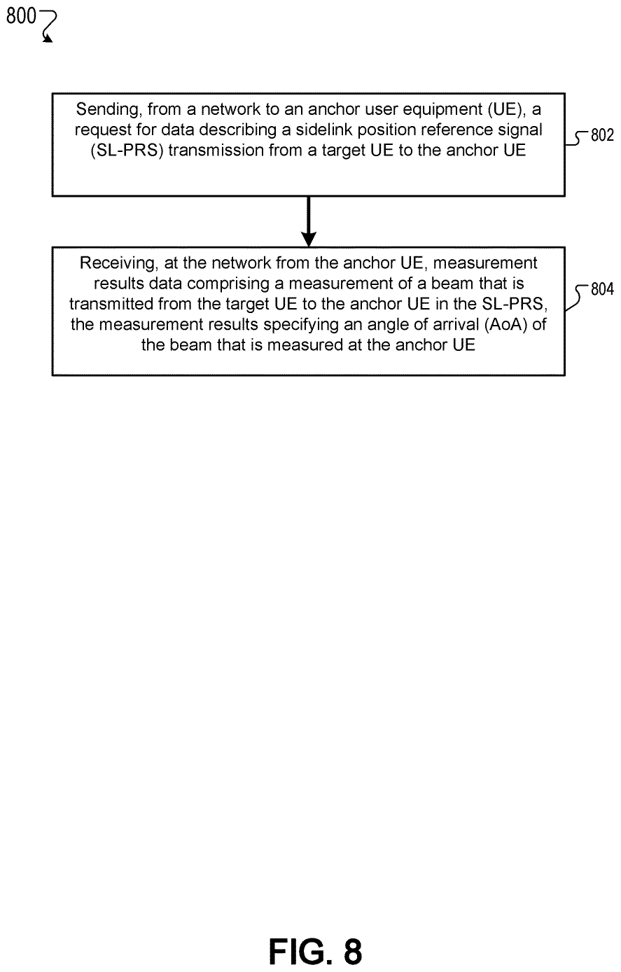

FIG. 8 illustrates a flowchart of an example method 800, according to some implementations. For clarity of presentation, the description that follows generally describes method 800 in the context of the other figures in this description. For example, method 800 can be performed by an LMF of the core network 140 of FIG. 1. It will be understood that method 800 can be performed, for example, by any suitable system, environment, software, hardware, or a combination of systems, environments, software, and hardware, as appropriate. In some implementations, various steps of method 800 can be run in parallel, in combination, in loops, or in any order.

In an example, process 800 includes sending (802), from a network to an anchor user equipment (UE), a request for data describing a sidelink position reference signal (SL-PRS) transmission from a target UE to the anchor UE. The process 800 includes receiving (804), at the network from the anchor UE, measurement results data comprising a measurement of a beam that is transmitted from the target UE to the anchor UE in the SL-PRS, the measurement results specifying an angle of arrival (AoA) of the beam that is measured at the anchor UE.

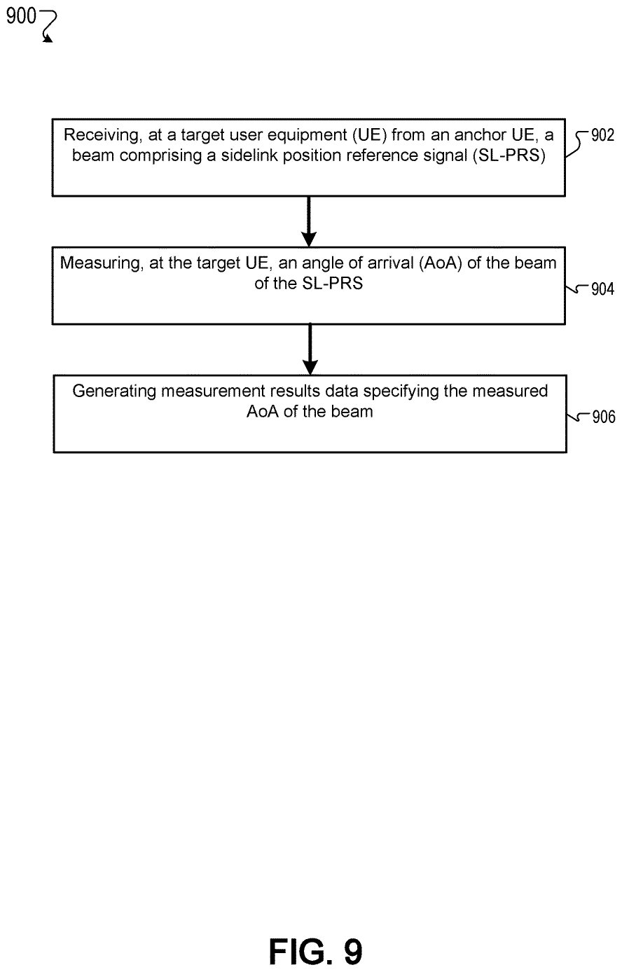

FIG. 9 illustrates a flowchart of an example method 900, according to some implementations. For clarity of presentation, the description that follows generally describes method 900 in the context of the other figures in this description. For example, method 900 can be performed by UE 105 of FIG. 1. It will be understood that method 900 can be performed, for example, by any suitable system, environment, software, hardware, or a combination of systems, environments, software, and hardware, as appropriate. In some implementations, various steps of method 900 can be run in parallel, in combination, in loops, or in any order.

In an example, process 900 includes receiving (902), at a target user equipment (UE) from an anchor UE, a beam comprising a sidelink position reference signal (SL-PRS). The process 900 includes measuring (904), at the target UE, an angle of arrival (AoA) of the beam of the SL-PRS. The process 900 includes generating (906) measurement results data specifying the measured AoA of the beam.

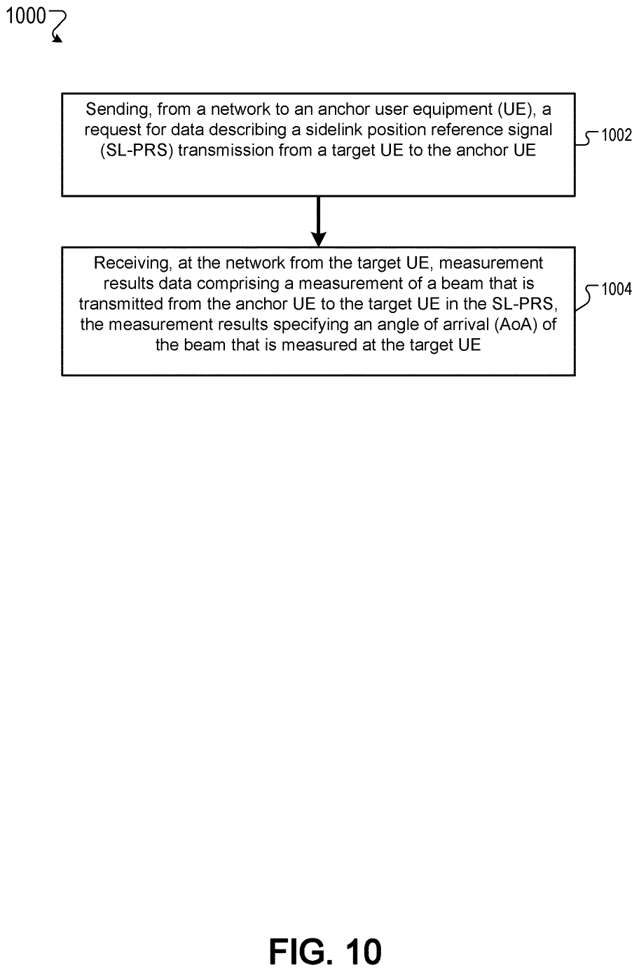

FIG. 10 illustrates a flowchart of an example method 1000, according to some implementations. For clarity of presentation, the description that follows generally describes method 1000 in the context of the other figures in this description. For example, method 1000 can be performed by an LMF of the core network 140 of FIG. 1. It will be understood that method 1000 can be performed, for example, by any suitable system, environment, software, hardware, or a combination of systems, environments, software, and hardware, as appropriate. In some implementations, various steps of method 1000 can be run in parallel, in combination, in loops, or in any order.

In an example, process 900 includes sending (1002), from a network to an anchor user equipment (UE), a request for data describing a sidelink position reference signal (SL-PRS) transmission from a target UE to the anchor UE. The process 1000 includes receiving (1004), at the network from the target UE, measurement results data comprising a measurement of a beam that is transmitted from the anchor UE to the target UE in the SL-PRS, the measurement results specifying an angle of arrival (AoA) of the beam that is measured at the target UE.

The example methods 800, 900, or 1000 shown in FIGS. 8-10 can be modified or reconfigured to include additional, fewer, or different steps (not shown in FIGS. 8-10), which can be performed in the order shown or in a different order.

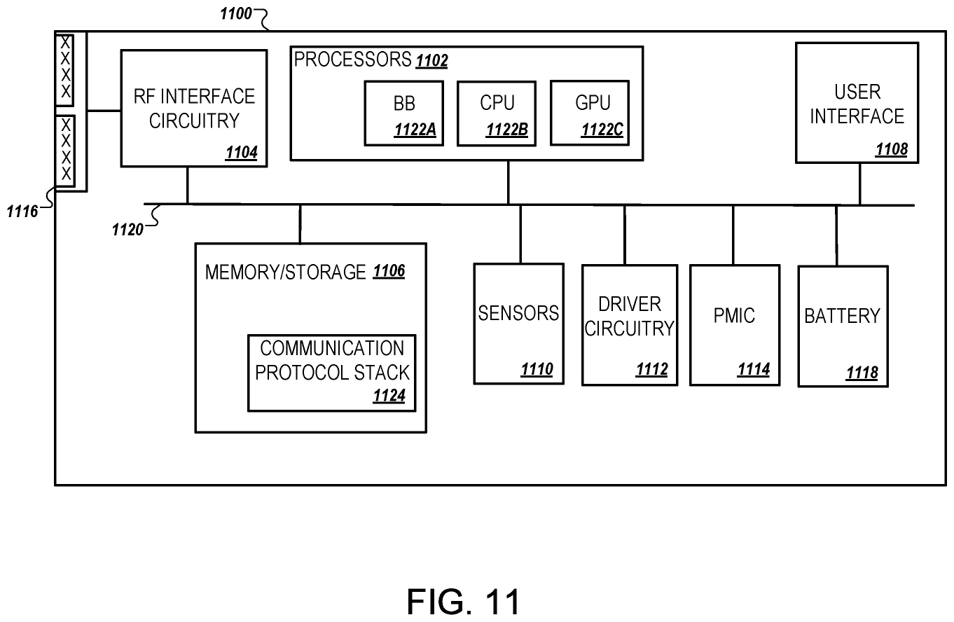

FIG. 11 illustrates an example UE 1100, according to some implementations. The UE 1100 may be similar to and substantially interchangeable with UEs 105 of FIG. 1.

The UE 1100 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1100 may include processors 1102, RF interface circuitry 1104, memory/storage 1106, user interface 1108, sensors 1110, driver circuitry 1112, power management integrated circuit (PMIC) 1114, one or more antenna(s) 1116, and battery 1118. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1120, which may represent any type of interface, input/output, bus (local, system, or expansion), transmission line, trace, optical connection, etc. that allows various circuit components (on common or different chips or chipsets) to interact with one another.

The processors 1102 may include processor circuitry such as, for example, baseband processor circuitry (BB) 1122A, central processor unit circuitry (CPU) 1122B, and graphics processor unit circuitry (GPU) 1122C. The processors 1102 may include any type of circuitry or processor circuitry that executes or otherwise operates computer-executable instructions, such as program code, software modules, or functional processes from memory/storage 1106 to cause the UE 1100 to perform operations as described herein.

In some implementations, the baseband processor circuitry 1122A may access a communication protocol stack 1124 in the memory/storage 1106 to communicate over a 3GPP compatible network. In general, the baseband processor circuitry 1122A may access the communication protocol stack to perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1104. The baseband processor circuitry 1122A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1106 may include one or more non-transitory, computer-readable media that includes instructions (for example, communication protocol stack 1124) that may be executed by one or more of the processors 1102 to cause the UE 1100 to perform various operations described herein. The memory/storage 1106 include any type of volatile or non-volatile memory that may be distributed throughout the UE 1100. In some implementations, some of the memory/storage 1106 may be located on the processors 1102 themselves (for example, L1 and L2 cache), while other memory/storage 1106 is external to the processors 1102 but accessible thereto via a memory interface. The memory/storage 1106 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1104 may include transceiver circuitry and radio frequency front module (RFEM) that allows the UE 1100 to communicate with other devices over a radio access network. The RF interface circuitry 1104 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1116 and proceed to filter and amplify (with a low-noise amplifier) the signal. The signal may be provided to a receiver of the transceiver that downconverts the RF signal into a baseband signal that is provided to the baseband processor of the processors 1102.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1116. In various implementations, the RF interface circuitry 1104 may be configured to transmit/receive signals in a manner compatible with NR access technologies.

The antenna(s) 1116 may include one or more antenna elements to convert electrical signals into radio waves to travel through the air and to convert received radio waves into electrical signals. The antenna elements may be arranged into one or more antenna panels. The antenna(s) 1116 may have antenna panels that are omnidirectional, directional, or a combination thereof to enable beamforming and multiple input, multiple output communications. The antenna(s) 1116 may include microstrip antennas, printed antennas fabricated on the surface of one or more printed circuit boards, patch antennas, phased array antennas, etc. The antenna(s) 1116 may have one or more panels designed for specific frequency bands including bands in FR1 or FR2.

The user interface 1108 includes various input/output (I/O) devices designed to enable user interaction with the UE 1100. The user interface 1108 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1100.

The sensors 1110 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1112 may include software and hardware elements that operate to control particular devices that are embedded in the UE 1100, attached to the UE 1100, or otherwise communicatively coupled with the UE 1100. The driver circuitry 1112 may include individual drivers allowing other components to interact with or control various input/output (I/O) devices that may be present within, or connected to, the UE 1100. For example, driver circuitry 1112 may include a display driver to control and allow access to a display device, a touchscreen driver to control and allow access to a touchscreen interface, sensor drivers to obtain sensor readings of sensors 1110 and control and allow access to sensors 1110, drivers to obtain actuator positions of electro-mechanic components or control and allow access to the electro-mechanic components, a camera driver to control and allow access to an embedded image capture device, audio drivers to control and allow access to one or more audio devices.

The PMIC 1114 may manage power provided to various components of the UE 1100. In particular, with respect to the processors 1102, the PMIC 1114 may control power-source selection, voltage scaling, battery charging, or DC-to-DC conversion.

In some implementations, the PMIC 1114 may control, or otherwise be part of, various power saving mechanisms of the UE 1100. A battery 1118 may power the UE 1100, although in some examples the UE 1100 may be mounted deployed in a fixed location and may have a power supply coupled to an electrical grid. The battery 1118 may be a lithium ion battery, a metal-air battery, such as a zinc-air battery, an aluminum-air battery, a lithium-air battery, and the like. In some implementations, such as in vehicle-based applications, the battery 1118 may be a typical lead-acid automotive battery.

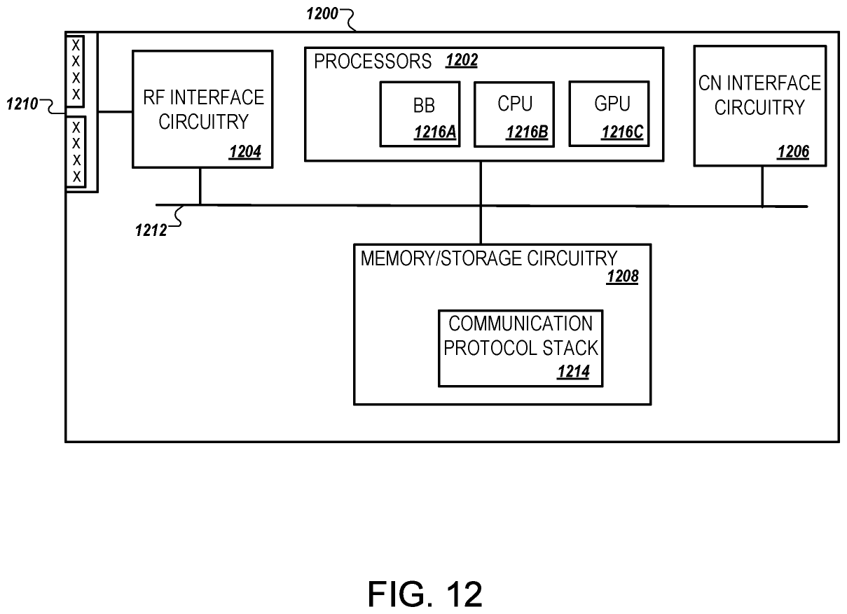

FIG. 12 illustrates an example access node 1200 (e.g., a base station or gNB), according to some implementations. The access node 1200 may be similar to and substantially interchangeable with base stations 110. The access node 1200 may include processors 1202, RF interface circuitry 1204, core network (CN) interface circuitry 1206, memory/storage circuitry 1208, and one or more antenna(s) 1210.

The components of the access node 1200 may be coupled with various other components over one or more interconnects 1212. The processors 1202, RF interface circuitry 1204, memory/storage circuitry 1208 (including communication protocol stack 1214), antenna(s) 1210, and interconnects 1212 may be similar to like-named elements shown and described with respect to FIG. 11. For example, the processors 1202 may include processor circuitry such as, for example, baseband processor circuitry (BB) 1216A, central processor unit circuitry (CPU) 1216B, and graphics processor unit circuitry (GPU) 1216C.

The CN interface circuitry 1206 may provide connectivity to a core network, for example, a 5th Generation Core network (5GC) using a 5GC-compatible network interface protocol such as carrier Ethernet protocols, or some other suitable protocol. Network connectivity may be provided to/from the access node 1200 via a fiber optic or wireless backhaul. The CN interface circuitry 1206 may include one or more dedicated processors or FPGAs to communicate using one or more of the aforementioned protocols. In some implementations, the CN interface circuitry 1206 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1200 that operates in an NR or 5G system (for example, a gNB), and the term “E-UTRAN node” or the like may refer to an access node 1200 that operates in an LTE or 4G system (e.g., an eNB). According to various implementations, the access node 1200 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1200 may be implemented as one or more software entities running on server computers as part of a virtual network, which may be referred to as a CRAN and/or a virtual baseband unit pool (vBBUP). In V2X scenarios, the access node 1200 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 is a method including sending, from a network to an anchor user equipment (UE), a request for data describing a sidelink position reference signal (SL-PRS) transmission from a target UE to the anchor UE; and receiving, at the network from the anchor UE, measurement results data comprising a measurement of a beam that is transmitted from the target UE to the anchor UE in the SL-PRS, the measurement results data specifying an angle of arrival (AoA) of the beam that is measured at the anchor UE.

Example 2 includes the method of example 1, further including determining a location of the target UE with respect to a node of the network based on the measurement results data.

Example 3 includes the method of any of examples 1 or 2, further including receiving assistance data from the anchor UE, the assistance data describing a synchronization source of the anchor UE, an identity of the anchor UE, or sidelink synchronization signal block (S-SSB) information for the anchor UE.

Example 4 includes the method of any of examples 1 to 3, further including receiving configuration data from the anchor UE, the configuration data describing one or more SL-PRS resources used for the SL-PRS transmission, the one or more SL-PRS resources including a beam direction used by the target UE.

Example 5 includes the method of any of examples 1 to 4, wherein the measurement results data further include a SL-PRS reference signal receive power (RSRP) for the beam.

Example 6 includes the method of any of examples 1 to 5, wherein the measurement results data further include a SL-PRS reference signal received path power (RSRPP) for the beam.

Example 7 includes the method of any of examples 1 to 6, wherein the measurement results data further include a SL-PRS time stamp and selected beam identifier for the measurement of the beam.

Example 8 includes the method of any of examples 1 to 7, wherein the AoA of the measurement results data is based on a global coordinate system for the anchor UE, an angle of the global coordinate system being in relation to a geographic direction.

Example 9 includes the method of any of examples 1 to 8, wherein the AoA of the measurement results data is based on a local coordinate system for the anchor UE, an angle of the local coordinate system being in relation to a previous position in the local coordinate system of the anchor UE, the local coordinate system being related to a global coordinate system by the anchor UE.

Example 10 includes the method of any of examples 1 to 9, wherein the AoA of the measurement results data is based on a local coordinate system for the anchor UE, an angle of the local coordinate system being in relation to a configured SL-PRS beam direction.

Example 11 includes the method of any of examples 1 to 10, wherein the request for data describing the SL-PRS transmission requests one or more of i) a number of requested SL-PRS resource sets and SL-PRS resources per set, ii) spatial relation information that specifies a SL-PRS resource identifier for the SL-PRS resource, or iii) sidelink synchronization signal block (S-SSB) information associated with the SL-PRS.

Example 12 includes the method of any of examples 1 to 11, wherein the AoA is determined to be at a specific angle with respect to a geographical north direction.

Example 13 is a method including receiving, at a target user equipment (UE) from an anchor UE, a beam comprising a sidelink position reference signal (SL-PRS); measuring, at the target UE, an angle of arrival (AoA) of the beam of the SL-PRS; and generating measurement results data specifying the measured AoA of the beam.

Example 14 includes the method of example 13, further including determining, at the target UE, a location of the target UE with respect to a node of a network based on the measurement results, the measurement results further specifying one or more other measured AoAs of respective other SL-PRSs from respective other anchor UEs.

Example 15 includes the method of any of examples 13 to 14, further including receiving, at the target UE, assistance data from the anchor UE, the assistance data describing a synchronization source of the anchor UE, an identity of the anchor UE, or sidelink synchronization signal block (S-SSB) information for the anchor UE.

Example 16 includes the method of any of examples 13 to 15, wherein the measurement results further include a SL-PRS reference signal receive power (RSRP) for the beam.

Example 17 includes the method of any of examples 13 to 16, wherein the measurement results further include a SL-PRS reference signal received path power (RSRPP) for the beam.

Example 18 includes the method of any of examples 13 to 17, wherein the measurement results further include a SL-PRS time stamp and selected beam identifier for the measurement of the beam.

Example 19 includes the method of any of examples 13 to 18, wherein the AoA of the measurement results is based on a global coordinate system for the target UE, an angle of the global coordinate system being in relation to a geographic direction.

Example 20 includes the method of any of examples 13 to 19, wherein the AoA of the measurement results is based on a local coordinate system for the target UE, an angle of the local coordinate system being in relation to a previous position in the local coordinate system of the target UE, the local coordinate system being related to a global coordinate system by the target UE.

Example 21 includes the method of any of examples 13 to 20, wherein the AoA of the measurement results is based on a local coordinate system for the target UE, an angle of the local coordinate system being in relation to a configured SL-PRS beam direction.

Example 22 includes the method of any of examples 13 to 21, wherein the SL-PRS is received responsive to a request received at the anchor UE from a network, the request requesting data describing the SL-PRS transmission that include one or more of i) a number of requested SL-PRS resource sets and SL-PRS resources per set, ii) spatial relation information that specifies a SL-PRS resource identifier of the SL-PRS resource, or iii) sidelink synchronization signal block (S-SSB) information associated with the SL-PRS.

Example 23 includes the method of any of examples 13 to 22, wherein a location of the anchor UE with respect to a node of a network is known.

Example 24 is a method including sending, from a network to an anchor user equipment (UE), a request for data describing a sidelink position reference signal (SL-PRS) transmission from a target UE to the anchor UE; and receiving, at the network from the target UE, measurement results data comprising a measurement of a beam that is transmitted from the anchor UE to the target UE in the SL-PRS, the measurement results data specifying an angle of arrival (AoA) of the beam that is measured at the target UE.

Example 25 includes the method of example 24, further including determining a location of the target UE with respect to a node of the network based on the measurement results data.

Example 26 includes the method of any of examples 24 or 25, further including receiving assistance data from the anchor UE, the assistance data describing a synchronization source of the anchor UE, an identity of the anchor UE, or sidelink synchronization signal block (S-SSB) information for the anchor UE.

Example 27 includes the method of any of examples 24 to 26, further including receiving configuration data from the anchor UE, the configuration data describing one or more SL-PRS resources used for the SL-PRS transmission, the one or more SL-PRS resources including a beam direction used by the anchor UE.

Example 28 includes the method of any of examples 24 to 27, wherein the measurement results data further include a SL-PRS reference signal receive power (RSRP) for the beam.

Example 29 includes the method of any of examples 24 to 28, wherein the measurement results data further include a SL-PRS reference signal received path power (RSRPP) for the beam.

Example 30 includes the method of any of examples 24 to 29, wherein the measurement results data further include a SL-PRS time stamp and selected beam identifier for the measurement of the beam.

Example 31 includes the method of any of examples 24 to 30, wherein the AoA of the measurement results data is based on a global coordinate system for the target UE, an angle of the global coordinate system being in relation to a geographic direction.

Example 32 includes the method of any of examples 24 to 31, wherein the AoA of the measurement results data is based on a local coordinate system for the target UE, an angle of the local coordinate system being in relation to a previous position in the local coordinate system of the target UE, the local coordinate system being related to a global coordinate system by the target UE.

Example 33 includes the method of any of examples 24 to 32, wherein the AoA of the measurement results data is based on a local coordinate system for the target UE, an angle of the local coordinate system being in relation to a configured SL-PRS beam direction.

Example 34 includes the method of any of examples 24 to 33, wherein the request for data describing the SL-PRS transmission requests one or more of i) a number of requested SL-PRS resource sets and SL-PRS resources per set, ii) spatial relation information that specifies a SL-PRS resource identifier of the SL-PRS resource, or iii) sidelink synchronization signal block (S-SSB) information associated with the SL-PRS.

Example 35 includes the method of any of examples 24 to 34, wherein a location of the anchor UE with respect to a node of the network is known.

Example 36 includes a non-transitory computer storage medium encoded with instructions that, when executed by one or more computers, cause the one or more computers to perform the method of any of examples 1 to 35.

Example 37 includes a system comprising one or more processors and one or more storage devices on which are stored instructions that are operable, when executed by the one or more processors, to cause the one or more processors to perform the method of any of examples 1 to 35.

Example 38 includes an apparatus comprising one or more baseband processors configured to perform the operations of any of examples 1 to 35.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1-37. (canceled)

38. One or more processors configured to, when executing instructions stored in a memory, perform operations comprising:
encoding for sending, from a network to an anchor user equipment (UE), a request for data describing a sidelink position reference signal (SL-PRS) transmission from a target UE to the anchor UE; and
decoding, at the network from the anchor UE, measurement results data comprising a measurement of a beam that is transmitted from the target UE to the anchor UE in the SL-PRS, the measurement results data specifying an angle of arrival (AoA) of the beam that is measured at the anchor UE.

39. The one or more processors of claim 38, the operations further comprising:
determining a location of the target UE with respect to a node of the network based on the measurement results data.

40. The one or more processors of claim 38, the operations further comprising:
decoding assistance data from the anchor UE, the assistance data describing a synchronization source of the anchor UE, an identity of the anchor UE, or sidelink synchronization signal block (S-SSB) information for the anchor UE.

41. The one or more processors of claim 38, wherein the AoA is based on a global coordinate system for the anchor UE, an angle of the global coordinate system being in relation to a geographic direction.

42. The one or more processors of claim 38, wherein the AoA is based on a local coordinate system for the anchor UE, an angle of the local coordinate system being in relation to a previous position in the local coordinate system of the anchor UE, the local coordinate system being related to a global coordinate system by the anchor UE.

43. The one or more processors of claim 38, wherein the AoA is based on a local coordinate system for the anchor UE, an angle of the local coordinate system being in relation to a configured SL-PRS beam direction.

44. The one or more processors of claim 38, wherein the request for data describing the SL-PRS transmission requests one or more of i) a number of requested SL-PRS resource sets and SL-PRS resources per set, ii) spatial relation information that specifies a SL-PRS resource identifier for the SL-PRS resource, or iii) sidelink synchronization signal block (S-SSB) information associated with the SL-PRS.

45. The one or more processors of claim 38, wherein the AoA is determined to be at a specific angle with respect to a geographical north direction.

46. An apparatus comprising:
a memory; and
one or more processors configured to, when executing instructions stored in the memory, perform operations comprising:
decoding, at a target user equipment (UE) from an anchor UE, a beam comprising a sidelink position reference signal (SL-PRS) transmission;
measuring, at the target UE, an angle of arrival (AoA) of the beam of the SL-PRS; and
generating measurement results data specifying the AoA of the beam.

47. The apparatus of claim 46, the operations further comprising:
determining, at the target UE, a location of the target UE with respect to a node of a network based on the measurement results, the measurement results further specifying one or more other measured AoAs of respective other SL-PRSs from respective other anchor UEs.

48. The apparatus of claim 46, the operations further comprising:
decoding, at the target UE, assistance data from the anchor UE, the assistance data describing a synchronization source of the anchor UE, an identity of the anchor UE, or sidelink synchronization signal block (S-SSB) information for the anchor UE.

49. The apparatus of claim 46, wherein the measurement results further include a SL-PRS time stamp and selected beam identifier for the measurement of the beam.

50. The apparatus of claim 46, wherein the AoA is based on a global coordinate system for the target UE, an angle of the global coordinate system being in relation to a geographic direction.

51. The apparatus of claim 46, wherein the AoA is based on a local coordinate system for the target UE, an angle of the local coordinate system being in relation to a previous position in the local coordinate system of the target UE, the local coordinate system being related to a global coordinate system by the target UE.

52. The apparatus of claim 46, wherein the AoA is based on a local coordinate system for the target UE, an angle of the local coordinate system being in relation to a configured SL-PRS beam direction.

53. The apparatus of claim 46, wherein the SL-PRS is received responsive to a request received at the anchor UE from a network, the request requesting data describing the SL-PRS that include one or more of i) a number of requested SL-PRS resource sets and SL-PRS resources per set, ii) spatial relation information that specifies a SL-PRS resource identifier of the SL-PRS resource, or iii) sidelink synchronization signal block (S-SSB) information associated with the SL-PRS.

54. A method for wireless communication, comprising:
encoding, from a network to an anchor user equipment (UE), a request for data describing a sidelink position reference signal (SL-PRS) transmission from a target UE to the anchor UE; and
decoding, at the network from the target UE, measurement results data comprising a measurement of a beam that is transmitted from the anchor UE to the target UE in the SL-PRS, the measurement results data specifying an angle of arrival (AA) of the beam that is measured at the target UE.

55. The method of claim 54, further comprising:
determining a location of the target UE with respect to a node of the network based on the measurement results data.

56. The method of claim 54, further comprising:
decoding assistance data from the anchor UE, the assistance data describing a synchronization source of the anchor UE, an identity of the anchor UE, or sidelink synchronization signal block (S-SSB) information for the anchor UE.

57. The method of claim 54, further comprising:
decoding configuration data from the anchor UE, the configuration data describing one or more SL-PRS resources used for the SL-PRS transmission, the one or more SL-PRS resources including a beam direction used by the anchor UE.
